(19) United States
(12) Patent Application Publication
(10) Pub. No.: US 2026/0326465 A1
(43) Pub. Date: Oct. 22, 2026

(54) ELECTRONIC DEVICE AND RECORDING DEVICE

(71) Applicant: SEIKO EPSON CORPORATION, Tokyo (JP)

(72) Inventors: Sotaro SUWA, SHIOJIRI-SHI (JP); Takeru OGUCHI, CHINO-SHI (JP); Tetsuji YATSUNAMI, OKAYA-SHI (JP)

(21) Appl. No.: 19/649,349

(22) Filed: Apr. 16, 2026

(30) Foreign Application Priority Data
Apr. 17, 2025 (JP) 2025-067994

(51) Int. Cl. B41J 29/02; B41J 29/13

(52) U.S. Cl. CPC B41J 29/02; B41J 29/13

(57) ABSTRACT

An electronic device includes a frame, a cable disposed along the frame, and a guide part attached to the frame and configured to guide the cable, and the frame is formed by welding a first metal plate and a second metal plate in a welding area, the cable overlaps the welding area, and the guide part is a flexible member interposed between the welding area and the cable.

The present application is based on, and claims priority from JP Application Serial Number 2025-067994, filed Apr. 17, 2025, the disclosure of which is hereby incorporated by reference herein in its entirety.

### BACKGROUND

### 1. Technical Field

The present disclosure relates to an electronic device and a recording device.

### 2. Related Art

According to the related art, an electronic device including a wiring such as a flexible flat cable inside a housing is known. For example, JP-A-2017-34033 discloses an electronic device including an accommodation unit that accommodates a wiring.

JP-A-2017-34033 is an example of the related art.

However, the electronic device described in JP-A-2017-34033 has a problem in that it is difficult to protect the accommodated wiring. Specifically, the accommodation unit is configured such that the operation of an electronic component and the miniaturization of a control board are given priority. Therefore, the influence of contact with other members, external force, and the like on the wiring is not particularly taken into consideration. That is, there is a demand for an electronic device in which the wiring accommodated therein is protected.

### SUMMARY

According to an aspect of the present disclosure, an electronic device includes a frame, a cable disposed along the frame, and a guide part attached to the frame and configured to guide the cable, and the frame is formed by welding a first metal plate and a second metal plate in a welding area, the cable overlaps the welding area, and the guide part is a flexible member interposed between the welding area and the cable.

According to another aspect of the present disclosure, a recording device includes the above-described electronic device, and a recording unit that performs recording on a medium.

### BRIEF DESCRIPTION OF THE DRAWINGS

FIG. 1 is a perspective view showing the configuration of a printer according to an embodiment.

FIG. 2 is a schematic diagram showing the configuration of a recording unit and a medium conveyance path.

FIG. 3 is an enlarged view of a range A1 in FIG. 1.

FIG. 4 is an enlarged view of a range A2 in FIG. 3.

FIG. 5 is a cross-sectional view showing the arrangement of a cover part and a guide part.

FIG. 6 is a perspective view showing the form and the configuration of the guide part.

FIG. 7 is a perspective view showing the form of the guide part during assembly.

FIG. 8 is a perspective view showing the arrangement of the guide part and the cable with respect to a frame.

FIG. 9 is a cross-sectional view showing details of the arrangement of the guide part with respect to the cover part.

FIG. 10 is a cross-sectional view showing a method of attaching the cover part.

FIG. 11 is a schematic diagram illustrating the flexure of a round cable.

FIG. 12 is a schematic view showing the arrangement of the cover part and the guide part.

FIG. 13 is a schematic view showing the arrangement of the cover part and the guide part.

FIG. 14 is a schematic view showing the arrangement of the cover part and the guide part.

FIG. 15 is a schematic view showing the arrangement of the cover part and the guide part and the shape of the guide part.

FIG. 16 is a schematic view showing the arrangement of the cover part and the guide part.

FIG. 17 is a schematic view showing the arrangement of the cover part and the guide part and the shape of the guide part.

### DESCRIPTION OF EMBODIMENTS

In the embodiment described below, as an example of the recording device including the electronic device according to the present disclosure, a printer 1 which is an inkjet printer will be described with reference to the drawings. The printer 1 includes an electronic device 5 which is an example of the electronic device according to the present disclosure. The electronic device 5 can also be said to be the printer 1.

The electronic device according to the present disclosure is not limited to being provided in the recording device, and may be provided in, for example, a projector, a personal computer, a monitor, a scanner, a finisher, or the like. The recording device according to the present disclosure is not limited to an inkjet printer, and may be, for example, a laser printer, a dot impact printer, a thermal printer, or the like.

In each of the following drawings, X, Y, and Z axes, or A and B axes, which are coordinate axes perpendicular to one another, are given as necessary, and a direction indicated by an arrow is defined as a +direction and a direction opposite to the +direction is defined as a −direction. In the present embodiment, a state where the printer 1 is installed on a horizontal surface such as a floor will be described, and the +Z direction is also referred to as above and the −Z direction is also referred to as below. In the above state, the −Z direction coincides with a vertical direction. In each of the following drawings, the size of each member is made different from the actual size for the sake of convenience of illustration.

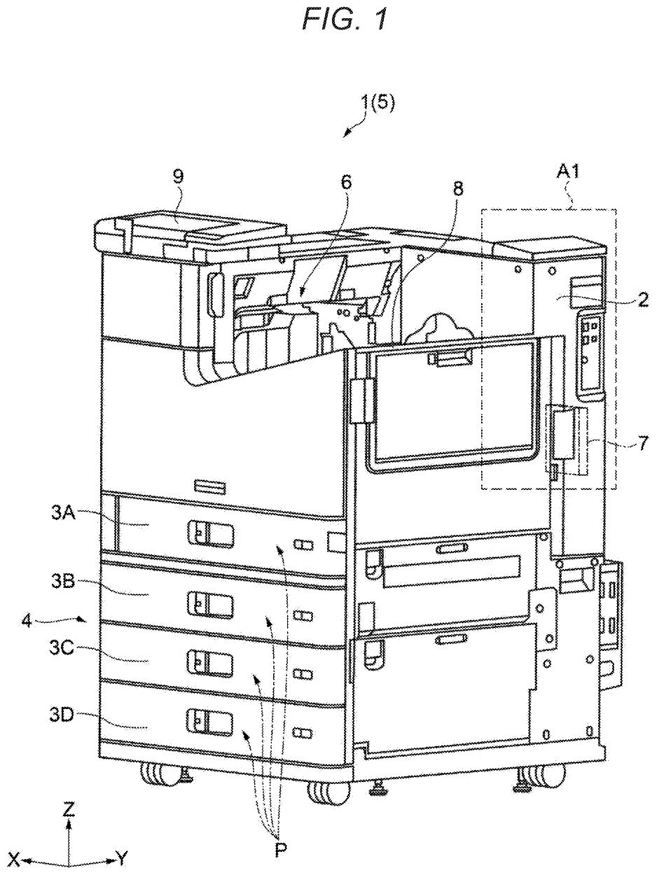

As illustrated in FIG. 1, the printer 1 according to the present embodiment includes a cover part 2, a medium cassette 3A, an extension unit 4, a discharge port 6, a control unit 7, a paper discharge tray 8, and an operation unit 9. As will be described later, the printer 1 also includes an ink storage unit 10, a recording unit 30 including a line head 32, and a frame 40, which is a structural member of the printer 1. In FIG. 1, a range A1 indicated by a rectangular broken line will be described later.

The printer 1 causes a liquid such as ink to adhere to a medium P, which is a single-cut sheet, in the recording unit 30, and thus performs printing. The printer 1 has a substantially rectangular parallelepiped shape. In the printer 1, a side surface facing the −Y direction is referred to as a front surface, and a side surface facing the +Y direction is referred to as a back surface.

The cover part 2 is an exterior member of the printer 1 and accommodates various elements of the printer 1 therein. For example, an ABS resin (acrylonitrile-butadiene-styrene copolymer) or the like is employed for the cover part 2.

The medium cassette 3A stores the medium P. The medium cassette 3A is disposed in the middle in the direction along the Z axis at the front of the printer 1. When the medium cassette 3A is pulled out in the −Y direction, the medium P can be replenished or replaced. Examples of the medium P include normal paper such as A-size or B-size paper, coated paper, photographic paper, resin sheet, and the like.

The extension unit 4 is disposed below the medium cassette 3A and includes medium cassettes 3B, 3C, 3D. Each of the medium cassettes 3B, 3C, 3D stores the medium P, similarly to the medium cassette 3A. In the extension unit 4, the medium cassette 3B, the medium cassette 3C, and the medium cassette 3D are disposed in this order directly below the medium cassette 3A. Also, when the medium cassettes 3B, 3C, 3D are pulled out in the −Y direction, the medium P can be replenished or replaced. In the medium cassettes 3B, 3C, 3D, media P of different types and sizes from the type and size of the medium P stored in the medium cassette 3A may be stored respectively in different orientations from the orientation of the medium P in the medium cassette 3A.

The medium P on which recording is performed is discharged from the discharge port 6. The discharge port 6 is disposed at an upper part of the printer 1 and faces the −X direction. The medium P is discharged in the −X direction from the discharge port 6. The paper discharge tray 8 is provided below the discharge port 6 in the −X direction.

The control unit 7 is electrically coupled to each of the elements of the printer 1 and comprehensively controls the operations of the elements. The control unit 7 is provided inside the cover part 2 and near the back surface, which is the rear of the device body. The control unit 7 includes a CPU (central processing unit), a system bus, a ROM (read-only memory), a RAM (random-access memory), and the like.

The control unit 7 causes the CPU to execute a predetermined control program and thus controls the printer 1. The ROM is a nonvolatile storage device and stores the control program to be executed by the CPU and data to be processed by the control program. The RAM forms a work area of the CPU. The CPU loads the control program read from the ROM or the like into the RAM, executes the loaded control program, and thus controls the printer 1.

The printer 1 may be operated from an information device such as a personal computer via the control unit 7. The printer 1 may include another control unit that can cooperate with the control unit 7. The arrangement of the control unit 7 is not limited to the above.

The medium P on which recording is performed is placed on the paper discharge tray 8. The paper discharge tray 8 is disposed at an upper part of the printer 1 and below the discharge port 6. The paper discharge tray 8 includes a surface forming an angle of depression when viewed from the −X direction. The medium P is discharged in the −X direction from the discharge port 6 and is stacked on the paper discharge tray 8.

The operation unit 9 accepts various operations and various settings input by the user of the printer 1. The operation unit 9 may display various information related to the printer 1. The operation unit 9 is provided at a front part of the device main body, specifically, provided at an upper part of the front surface of the printer 1 and an end part in the +X direction. The operation unit 9 is electrically coupled to the control unit 7 via a cable 80 or the like, described later. The operation unit 9 is, for example, a touch panel-type liquid crystal display. The operation unit 9 may include a physical button in addition to or instead of the liquid crystal display.

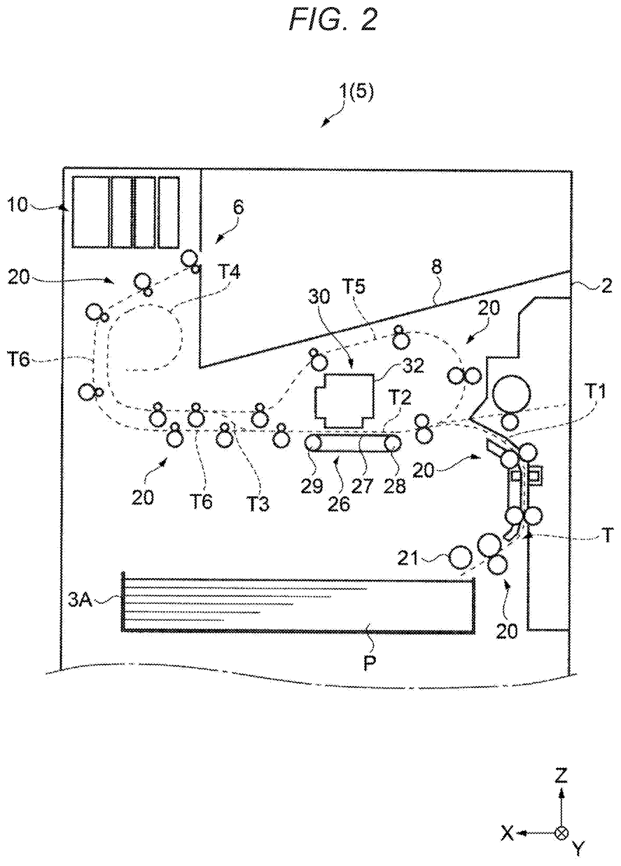

As illustrated in FIG. 2, the printer 1 includes a conveyance unit 20 inside the cover part 2, in addition to the ink storage unit 10 and the recording unit 30. The medium P is conveyed from the medium cassette 3A via a conveyance path T indicated by a broken line. In the following description, a direction in which the medium P is conveyed is also referred to as downstream, and a direction opposite to downstream is also referred to as upstream. In the following description with reference to FIG. 2, a state viewed from the −Y direction will be described unless otherwise specified.

The ink storage unit 10 supplies a liquid such as ink to the recording unit 30. The ink storage unit 10 is a container that stores a liquid and is attachable to and detachable from the printer 1. A plurality of ink storage units 10 are provided corresponding to various inks presenting colors such as black, cyan, magenta, and yellow. The various inks are sent from the ink storage unit 10 to the recording unit 30 via a pipe, not illustrated.

The recording unit 30 includes the line head 32. The line head 32 ejects the liquid such as ink onto the medium P conveyed by the conveyance unit 20 or the like, and thus performs recording. The line head 32 is an inkjet head. Although not illustrated, a plurality of nozzles are disposed on a nozzle surface of the line head 32 facing downward. The liquid such as ink is separately supplied from the ink storage unit 10 to the line head 32. The line head 32 ejects the liquid such as ink from the plurality of nozzles toward the medium P. Examples of the liquid include water-based, non-aqueous, and curable inks, and treatment solutions or the like.

The recording unit 30 may include a head that reciprocates along the Y axis, instead of the line head 32. The head is attached to, for example, a carriage, and the head together with the carriage is made to scan along the Y axis.

The line head 32 includes a piezoelectric element as an actuator, which is a drive unit. As the drive unit, for example, an electromechanical conversion element that displaces a vibrating plate as the actuator by electrostatic adsorption, or an electrothermal conversion element that discharges the liquid as droplets, using air bubbles generated by heating, may be used.

The recording unit 30 may include a cap unit, a wiper unit, and a waste liquid tank, not illustrated. The cap unit is in close contact with the nozzle surface of the line head 32, sucks the liquid such as ink from the plurality of nozzles, and thus performs a maintenance operation on the line head 32. The wiper unit slides on the nozzle surface and thus wipes off the liquid such as ink and dirt attached to the nozzle surface. The waste liquid tank is coupled to the cap unit via a pipe and stores the liquid such as ink sucked from the plurality of nozzles.

The conveyance path T extends from the medium cassette 3A and the medium cassettes 3B, 3C, 3D, not illustrated, to the paper discharge tray 8. The printer 1 includes a paper feed port, not illustrated, in the middle in the direction along the Z axis at the side surface facing the −X direction. The medium P can also be supplied to the printer 1 via the paper feed port, without being supplied from the medium cassette 3A and the extension unit 4.

The conveyance path T includes paths T1, T2, T3, T4, T5, T6. The path T1 extends substantially upward from an end part in the −X direction of the medium cassette 3A and the extension unit 4, not illustrated, to the vicinity of the line head 32 in the −X direction. The path T2 extends from the downstream end part of the path T1 to the +X direction of the line head 32 through an area where the conveyance path T faces the line head 32 in a direction along the Z axis. The path T2 branches into the path T3 and the path T6 at the downstream end. The path T6 extends in an arc shape upward from the downstream end of the path T2 to the discharge port 6.

The path T3 is employed when recording is performed on both the front and back surfaces of the medium P. The path T3 extends upward and in the +X direction with respect to the path T6 to the boundary between the path T4 and the path T5. The path T4 extends in an arc shape upward from the boundary into the +X direction. The path T5 extends from the coupling position of the path T3 and the path T4 to the upstream end part of the path T2 while taking a bypass above the line head 32. The paths T3, T4, T5 are reversing paths for reversing the surface of the medium P facing the line head 32.

The conveyance unit 20 is disposed at various places in the conveyance path T. The conveyance unit 20 conveys the medium P downstream or upstream in the conveyance path T. The conveyance unit 20 includes a pickup roller 21, a belt unit 26, and a plurality of roller pairs, not illustrated.

The pickup roller 21 is disposed at an end part of the medium cassette 3A in the −X direction, that is, near an upstream end of the path T1. The pickup roller 21 is driven to rotate counterclockwise by a drive motor, not illustrated, and feeds the medium P from the medium cassette 3A to the path T1. Since the pickup rollers and the accompanying roller pairs corresponding to the medium cassettes 3B, 3C, 3D have a configuration similar to that of the above-described medium cassette 3A, the description thereof will be omitted.

The belt unit 26 conveys the medium P while causing the medium P to face the line head 32 in the direction along the Z axis in the path T2. The belt unit 26 is disposed below the line head 32. The belt unit 26 includes a conveyance belt 27, a drive roller 28, and a driven roller 29.

The conveyance belt 27 is an endless belt and is stretched around the drive roller 28 and the driven roller 29. The conveyance belt 27 is disposed in an area including the space below the line head 32. In the area, the drive roller 28 is disposed in the −X direction, which is upstream, and the driven roller 29 is disposed in the +X direction, which is downstream.

The drive roller 28 is rotationally driven by a motor, not illustrated, and the conveyance belt 27 circulates counterclockwise. The driven roller 29 rotates in conjunction with the circulation of the conveyance belt 27. The medium P in a state of being in contact with the outer circumferential surface of the conveyance belt 27 is conveyed downstream by the circulation of the conveyance belt 27.

The medium P is conveyed from the medium cassette 3A through the path T1 by the pickup roller 21 or the like, and moves to the path T2. In the path T2, each color ink or the like is ejected at a predetermined timing from the line head 32 to the medium P conveyed in the +X direction. Thus, the liquid such as ink adheres to the medium P, and an image is recorded thereon. The medium P is conveyed through the path T2 and reaches the branching position between the path T3 and the path T6, which is the downstream end part of the path T2.

A flap, not illustrated, is provided at the branching position between the path T3 and the path T6. The flap switches the conveyance destination of the medium P to the path T3 or the path T6. When recording is performed on only one side of the medium P, the flap sets the conveyance destination of the medium P to the path T6. The medium P is conveyed through the path T6 and is discharged from the discharge port 6 to the paper discharge tray 8.

When recording is performed on both sides of the medium P, the flap sets the conveyance destination of the medium P to the path T3. The medium P advances from the path T3 to the path T4 and is temporarily conveyed to the vicinity of the downstream end part of the path T4. Subsequently, the medium P is reversely conveyed in the original direction through the path T4 and is delivered to the path T5. At this time, the medium P does not return to the path T3. In the path T5, the medium P is conveyed substantially in the −X direction above the recording unit 30. When the medium P passes above the recording unit 30, the recorded surface of the medium P faces upward.

The path T5 is curved in the −X direction of the recording unit 30, joins the path T1, and is coupled to the path T2. As the medium P is conveyed through the path T5, the surface of the medium P facing upward is reversed from the surface on which recording is already performed to the back surface on which recording is not performed yet. Then, the medium P is conveyed from the path T5 to the path T2, and after recording is performed on the back surface, the medium P is discharged to the paper discharge tray 8 via the path T6 and the discharge port 6.

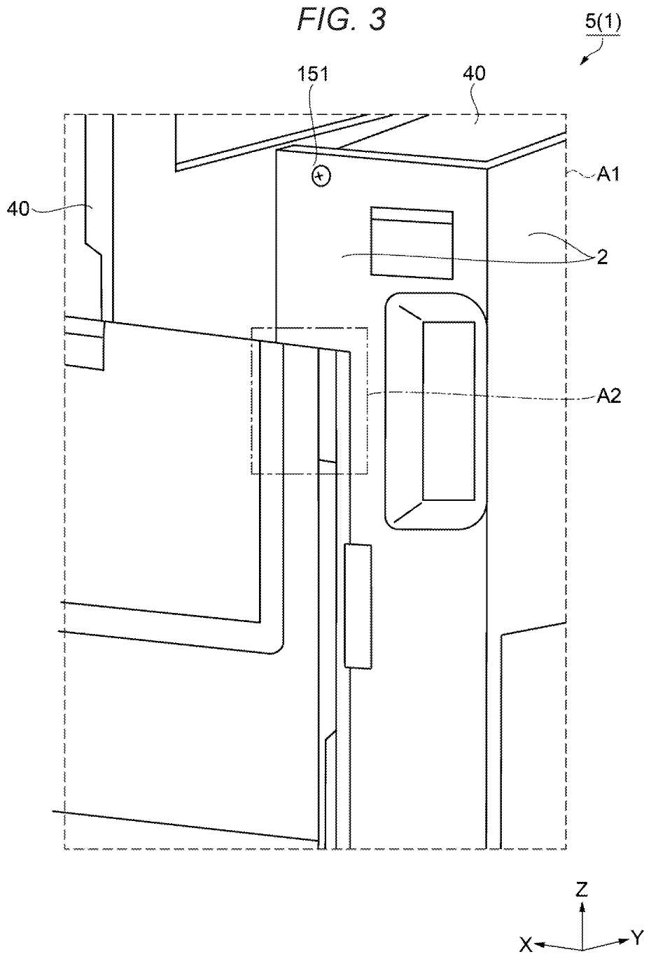

As illustrated in FIG. 3, the electronic device 5 according to the present embodiment includes the frame 40 and the cover part 2. In FIG. 3, the viewpoint is different from that in FIG. 1. In FIG. 3, a part of the cover part 2 and a part of the components accommodated inside the cover part 2 are omitted. A range A2 indicated by a rectangular chain line will be described later.

The frame 40 is a structural member that supports each component of the printer 1, which is the electronic device 5. The frame 40 is formed of a plurality of metal plate members, tubular members, and the like that are assembled together.

The cover part 2 includes a plurality of parts, and the plurality of parts are assembled to the frame 40 or the like. Specifically, the cover part 2 is attached to the frame 40 by a fastener 151 or the like. In the electronic device according to the present disclosure, the cover part 2 is not an essential component.

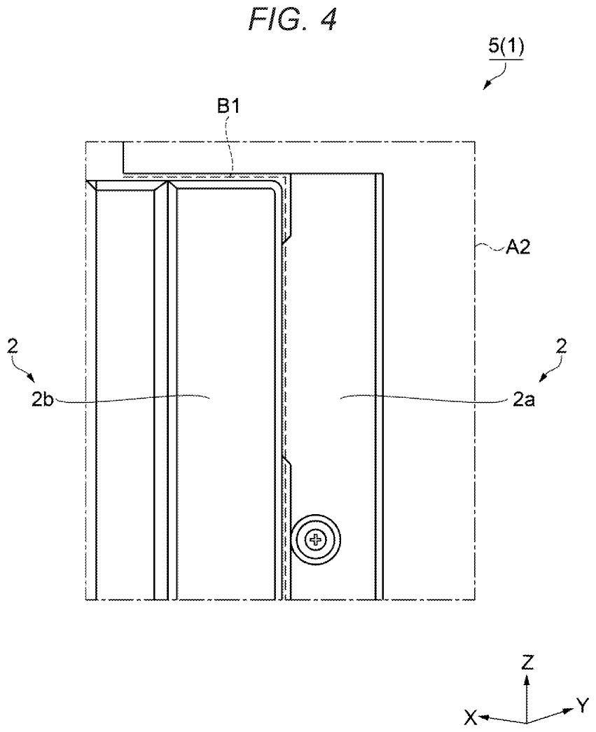

As shown in FIG. 4, the cover part 2 includes cover parts 2a, 2b as the plurality of parts. The boundary between the cover part 2a and the cover part 2b in terms of appearance is a boundary B1. In a substantially central area in FIG. 4, a part of the cover part 2a is laid beyond the boundary B1 and overlaps the inner side of the cover part 2b substantially in the +Y direction.

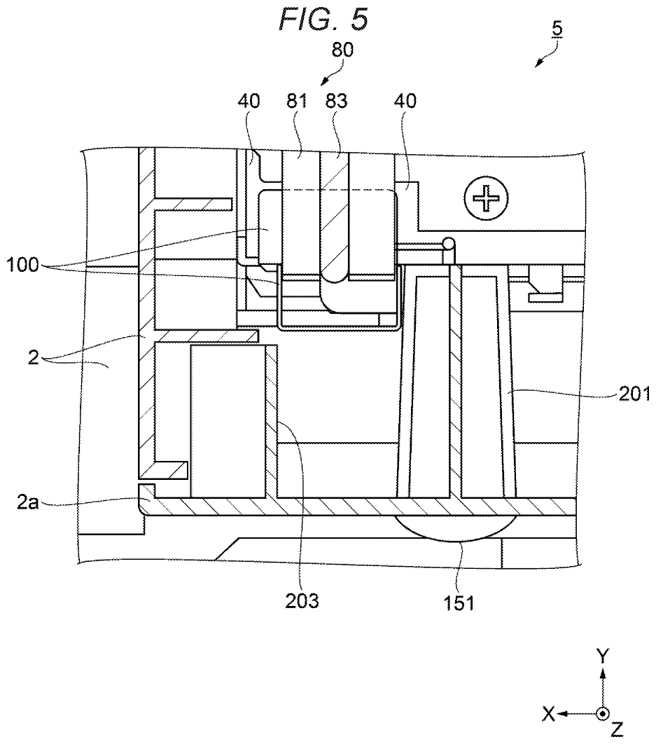

As illustrated in FIG. 5, the electronic device 5 includes the cable 80 and a guide part 100 in addition to the frame 40 and the cover part 2, 2a, described above.

The cable 80 is a signal line that electrically couples the operation unit 9 and the control unit 7, described above. The cable 80 is disposed along the frame 40. The cable 80 includes a flexible flat cable (FFC) 81 and a round cable 83. The round cable 83 is, for example, a USB cable. Also, the cable 80 may have an electrical wiring such as a harness.

The cable 80 is not limited to electrically coupling the operation unit 9 and the control unit 7. For example, the cable 80 may couple the control unit 7 to various movable parts, an external power supply, a power supply board, and the like, not illustrated. The cable 80 may couple various movable parts, an external power supply, a power supply board, and the like, not illustrated, to each other. The cable 80 may not directly couple the operation unit 9 and the control unit 7. The cable 80 may be provided between the operation unit 9 and the control unit 7, and may be coupled to, for example, a relay board.

The guide part 100 guides the cable 80. The guide part 100 is interposed between the cable 80 and the frame 40 and protects the cable 80. The cable 80 is routed over a relatively long distance from the rear to the front in the printer 1. Therefore, the cable 80 may expand in an unintended direction or come into contact with another member. Even in such a case, both the guiding and protection of the cable 80 can be achieved by the guide part 100.

The cover part 2a is attached to the frame 40 and covers the cable 80 and the guide part 100. The cover part 2a includes an insertion part 201 and a rib 203. The cover part 2a has an outer surface facing the −Y direction, which is the outside of the printer 1, and an inner surface facing the +Y direction, which is the inside of the printer 1. The cable 80 and the guide part 100 are disposed in the +Y direction of the cover part 2a. The cover part 2a blocks unnecessary access to the cable 80 and other members which are internal components of the printer 1.

The fastener 151 is inserted in the insertion part 201. The fastener 151 is fastened to the frame 40 from the outer surface side of the cover part 2a via the insertion part 201. Thus, the cover part 2a is attached to the frame 40. Since the cover part 2a and the frame 40 are attached to each other via the insertion part 201, the cover part 2a is easily and firmly attached. Also, since the guide part 100 is disposed when the cover part 2a is attached to the frame 40, the floating or play of the cable 80 is suppressed and the cable 80 can be suppressed from being sandwiched between the cover part 2a and the frame 40. The insertion part 201 may abut against the frame 40. Thus, the interval between the frame 40 and the cover part 2a can be defined by the insertion part 201, and the cover part 2a can be suppressed from being dented due to an external force.

The insertion part 201 is a truncated conical screw boss and protrudes in the +Y direction from the inner surface of the cover part 2a. The fastener 151 is inserted in the +Y direction in the insertion part 201, protrudes from the end part of the insertion part 201 in the +Y direction, and is screwed to the frame 40 in the corresponding area. The fastener 151 is, for example, a Phillips-head bolt. In the present disclosure, the insertion part 201 is not an essential component. For example, the fastener 151 may be attached to the frame 40 via a packing or the like.

The rib 203 improves the mechanical strength of the cover part 2a. The rib 203 protrudes from the inner surface of the cover part 2a toward the frame 40 in the +Y direction. In the state shown in FIG. 5 where the cover part 2a is attached to the frame 40, the guide part 100 is located between the rib 203 and the insertion part 201 when viewed from the −Y direction. Thus, since the guide part 100 avoids the rib 203 and the insertion part 201 and is disposed between the rib 203 and the insertion part 201, an excessive deformation of the guide part 100 due to contact with the rib 203 and the insertion part 201 can be suppressed. When the mechanical strength of the cover part 2a is ensured, the rib 203 may be omitted as appropriate.

The frame 40 extends along the X axis in the range shown in FIG. 5. When viewed in the direction along the frame 40, that is, when viewed from the −X direction, the insertion part 201 and the guide part 100 overlap each other. As described above, in the configuration in which the cable 80 is disposed at a position close to the insertion part 201, the floating and play of the cable 80 are suppressed by the guide part 100, and the cable 80 is suppressed from being sandwiched between the insertion part 201 and the frame 40. The rib 203, the insertion part 201, and the guide part 100 are not limited to the above-described arrangement.

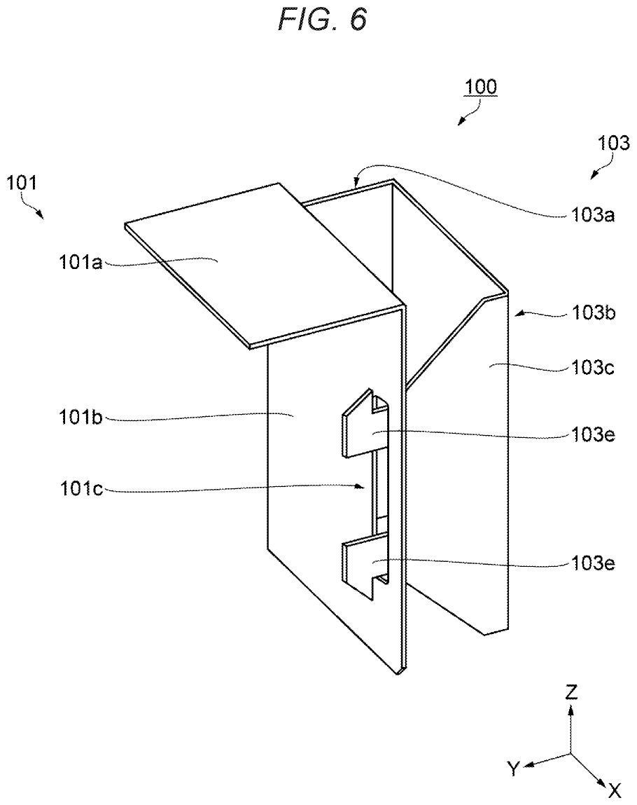

As illustrated in FIG. 6, the guide part 100 includes a protection part 101 and a holding part 103. The protection part 101 holds the holding part 103 and is disposed corresponding to the frame 40. The holding part 103 extends from the protection part 101 and protects the cable 80. The guide part 100 is a flexible member. The guide part 100 is formed of a sheet-shaped resin. Examples of the resin include polyester resins such as PET (polyethylene terephthalate), and PP (polypropylene), or the like. In the present embodiment, PET is applied.

The protection part 101 includes a first part 101a, a second part 101b, and an opening 101c. The first part 101a is a rectangular flat surface extending in the +Y direction, which is an example of a first direction, and extending along the XY plane. The second part 101b is a rectangular flat surface extending in the −Z direction, which is an example of a second direction intersecting the first direction, and extending along the XZ plane. The second part 101b is bent at a right angle to the first part 101a at the boundary with the first part 101a, when viewed from the +X direction.

Of the four sides of the first part 101a, a pair of opposing short sides is along the Y-axis, and a pair of opposing long sides is along the X-axis. Of the pair of long sides, the long side in the −Y direction overlaps one side of the second part 101b.

Of the four sides of the second part 101b, a pair of opposing short sides is along the X-axis, and a pair of opposing long sides is along the Z-axis. Of the pair of short sides, the upper short side is the one side of the second part 101b and overlaps the long side of the first part 101a in the −Y direction. Of the pair of long sides, the long side in the −X direction overlaps one side of a first surface 103a of the holding part 103, described later.

The opening 101c is disposed adjacent to the long side in the +X direction in the second part 101b. The opening 101c is an opening penetrating the second part 101b in a direction along the Y-axis. A distal end 103e, described later, of the holding part 103 is inserted in and engaged with the opening 101c of the protection part 101, and the protection part 101 and the holding part 103 are assembled together.

The holding part 103 has the first surface 103a, a second surface 103b, a surface 103c, and the distal end 103e. The first surface 103a and the second surface 103b, and the second surface 103b and the surface 103c are formed to continue from each other via a bend. In addition, the first surface 103a is bent and extends from the long side in the −X direction of the second part 101b of the protection part 101. When viewed from above, the first surface 103a, the second surface 103b, the surface 103c, and the second part 101b of the protection part 101 are formed in a rectangular shape.

The first surface 103a is a rectangular surface extending along the YZ plane and facing the −X direction. The second surface 103b is a rectangular surface extending along the XZ plane and facing the −Y direction, and is bent from the first surface 103a. The surface 103c is a substantially trapezoidal surface extending along the YZ plane and facing the +X direction. The distal end 103e is provided in an area corresponding to the upper base of the substantially trapezoidal surface 103c when viewed from the +X direction.

The guide part 100 may guide the cable 80. The above-described configuration and form of the guide part 100 are an example, and the present disclosure is not limited thereto. For example, the shape formed by the second part 101b of the protection part 101 and the holding part 103 may be a trapezoidal shape, a semicircular shape, a polygonal shape, or the like, when viewed from above.

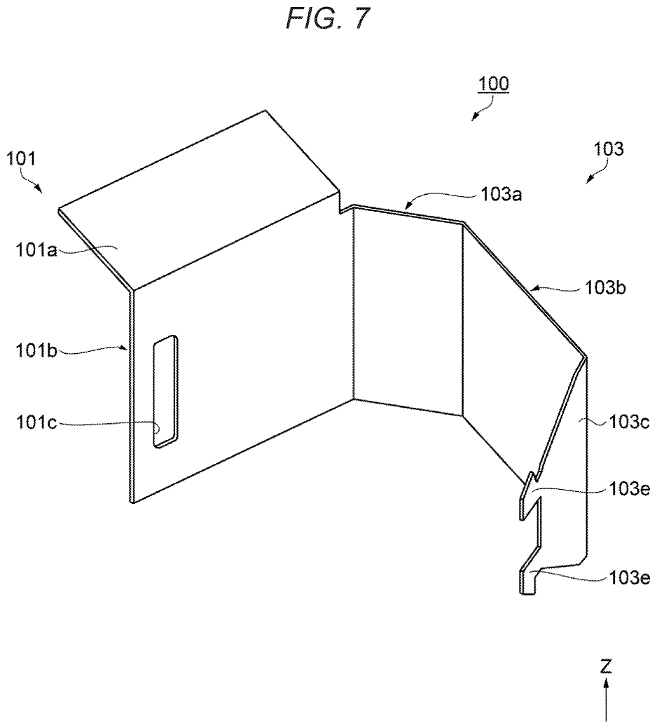

As shown in FIG. 7, the guide part 100 is formed by processing one resin sheet. Specifically, the guide part 100 is assembled by bending the boundary between the first part 101a and the second part 101b, the boundary between the second part 101b and the first surface 103a, the boundary between the first surface 103a and the second surface 103b, and the boundary between the second surface 103b and the surface 103c at substantially right angles. At the time of manufacturing the guide part 100, the guide part 100 may be bent after a perforated line or a fold is formed at the boundaries.

The opening 101c has a rectangular shape with long sides extending along the Z-axis. In a direction along the Z-axis, the length of the opening 101c is shorter than the length between the distal ends 103e of the holding part 103. Therefore, when the distal ends 103e are inserted into the opening 101c, the distal ends 103e and the opening 101c are engaged with each other and hardly come off. The distal ends 103e of the holding part 103 are engaged with and fixed to the opening 101c of the protection part 101. As described above, the holding part 103 is formed integrally with the protection part 101, surrounds the cable 80, and is fixed to the protection part 101. Therefore, the guiding of the cable 80 and the protection of the cable 80 can be achieved with a simple configuration.

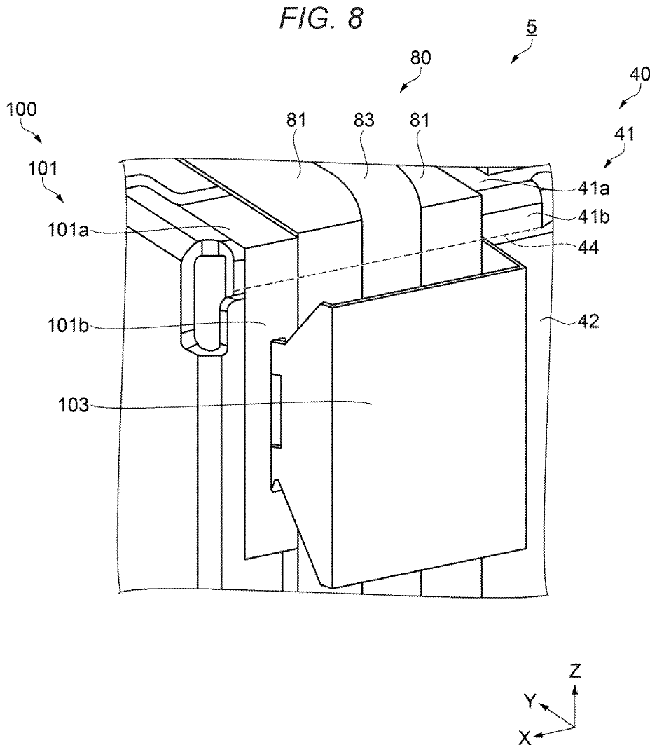

As illustrated in FIG. 8, the frame 40 includes a first metal plate 41 and a second metal plate 42. The first metal plate 41 and the second metal plate 42 are welded to each other in a welding area 44 indicated by a broken line, and form a part of the frame 40.

Specifically, the first metal plate 41 includes a first metal plate 41a extending along the XY plane and a first metal plate 41b extending along the XZ plane. The first metal plate 41a extends in the +Y direction, which is the first direction, and the first metal plate 41b extends in the −Z direction. The first metal plate 41a and the first metal plate 41b are bent at a substantially right angle at a boundary along the X axis, when viewed from the +X direction. The second metal plate 42 extends along the XZ plane and extends in the −Z direction, which is the second direction intersecting the first direction.

The welding area 44 extends along the X axis. In the welding area 44, the first metal plate 41b and the second metal plate 42 are welded together. The configuration and arrangement of the first metal plate 41 and the second metal plate 42 are an example, and the present disclosure is not limited thereto. For example, the welding area 44 to the second metal plate 42 may be provided at the boundary between the first metal plate 41a and the first metal plate 41b.

The cable 80 is disposed along the first metal plates 41a, 41b and the second metal plate 42, and is disposed to overlap the welding area 44. The protection part 101 of the guide part 100 is interposed between the welding area 44 and the cable 80. Specifically, the first part 101a of the protection part 101 is interposed between the first metal plate 41a and the cable 80. The second part 101b of the protection part 101 is interposed between the first metal plate 41b and the second metal plate 42, and the cable 80. The holding part 103 of the guide part 100 surrounds the cable 80. That is, the cable 80 is protected as the protection part 101 is interposed between the frame 40 and the cable 80. As the holding part 103 surrounds the cable 80, the cable 80 is held and guided.

Generally, when metal plates are welded together, a corner or a bulge may occur. Also, metal plates are often welded together at a position close to end parts of the metal plates. As described above, even when a corner or a bulge occurs in the welding area 44 or the cable 80 is provided near an end part of the metal plate, the cable 80 can be protected as the protection part 101 of the guide part 100 is interposed.

The cables 80 are arranged in the order of the FFC 81 and the round cable 83 from the side close to the frame 40. Thus, the guide part 100 protects the FFC 81 and the round cable 83 and suppresses damage thereto. As the FFC 81 is disposed close to the frame 40, the influence of electrical noise is reduced. Since the FFC 81 and the round cable 83 are guided by the guide part 100, a compact routing of the cable 80 is realized and space efficiency is improved. Also, in a configuration in which a wiring clamp member is provided in a protrusion or a hole in the frame 40 so as to guide the round cable 83, it is difficult to dispose the FFC 81 to overlap the round cable 83, but with the guide part 100, these cables can be disposed to overlap each other. The guide part 100 is attached to the frame 40 with an adhesive material such as a double-sided tape.

The cable 80 is not limited to including the FFC 81 and the round cable 83. For example, the cable 80 may include only the round cable 83. The cable 80 may include only the FFC 81. Even in this case, the FFC 81 can be disposed close to the frame 40 while avoiding sliding contact with the frame 40. Specifically, since the FFC 81 is guided by the guide part 100, damage to the FFC 81 is suppressed, and the occurrence of floating of the FFC 81 from the frame 40 is suppressed. Since the FFC 81 is disposed close to the frame 40 and the floating thereof is suppressed, the influence of electrical noise is reduced.

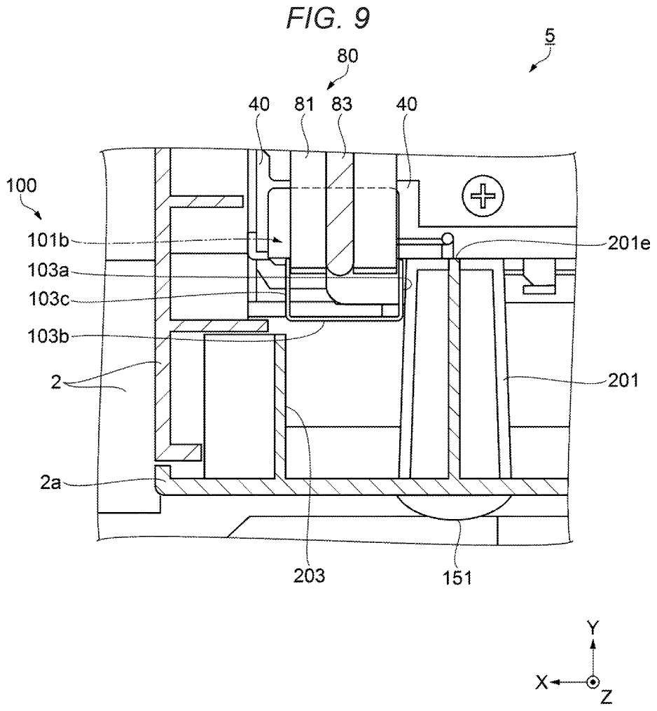

As shown in FIG. 9, the guide part 100 surrounds the cable 80 in a rectangular shape when viewed from above. In the state shown in FIG. 9 where the cover part 2a is attached to the frame 40, the first surface 103a of the holding part 103 faces the insertion part 201, and the second surface 103b faces the cover part 2a. In the state where the cover part 2a is attached to the frame 40, the guide part 100 and the cover part 2a are spaced apart from each other in a direction along the Y axis.

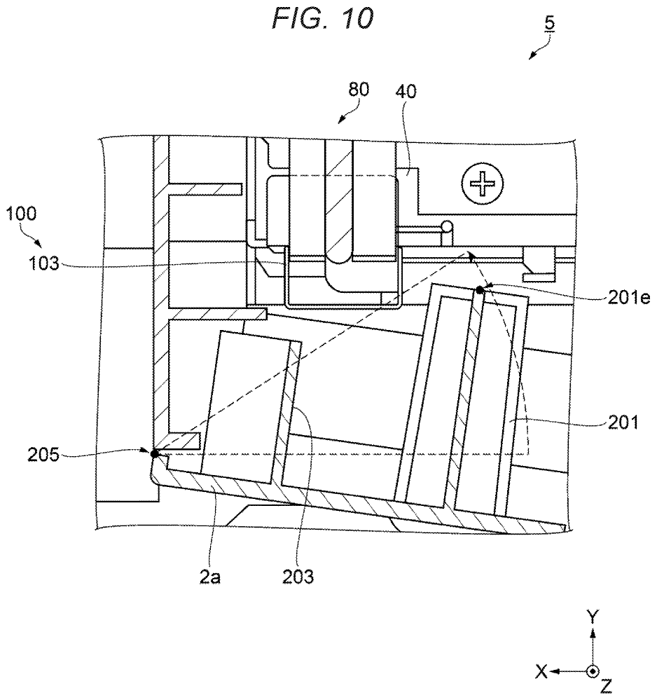

As illustrated in FIG. 10, to attach the cover part 2a to the frame 40, the cover part 2a is rotated counterclockwise about an end part 205 of the cover part 2a in the +X direction as the fulcrum, when viewed from above. Specifically, as described with reference to FIG. 4, a part of the cover part 2a overlaps the cover part 2b in the +Y direction. Therefore, after the +X direction side of the cover part 2a is inserted into the cover part 2b, the cover part 2a is attached to the frame 40 while being rotated counterclockwise with respect to the frame 40, as indicated by a dashed arrow in FIG. 10. The dashed arrow is the trajectory of a protruding end 201e of the insertion part 201. After the protruding end 201e is made to abut on the frame 40, the cover part 2a is fixed to the frame 40 with the fastener 151.

In the above-described process of attaching the cover part 2a to the frame 40, the insertion part 201 and the rib 203 do not come into contact with the holding part 103, and the insertion part 201 does not come into contact with the first surface 103a of the holding part 103. Therefore, when the cover part 2a is attached to the frame 40, the guide part 100 is prevented from being sandwiched between the insertion part 201 and the frame 40.

In the state shown in FIG. 9 where the cover part 2a is attached to the frame 40, the guide part 100 is located between the end part 205, which is the rotation center of the cover part 2a with respect to the frame 40, and the insertion part 201. Thus, since the cover part 2a is rotated and attached, a flow line of the insertion part 201 going around from the outside of the guide part 100 is formed. Therefore, the guide part 100 is prevented from being sandwiched between the insertion part 201 and the frame 40.

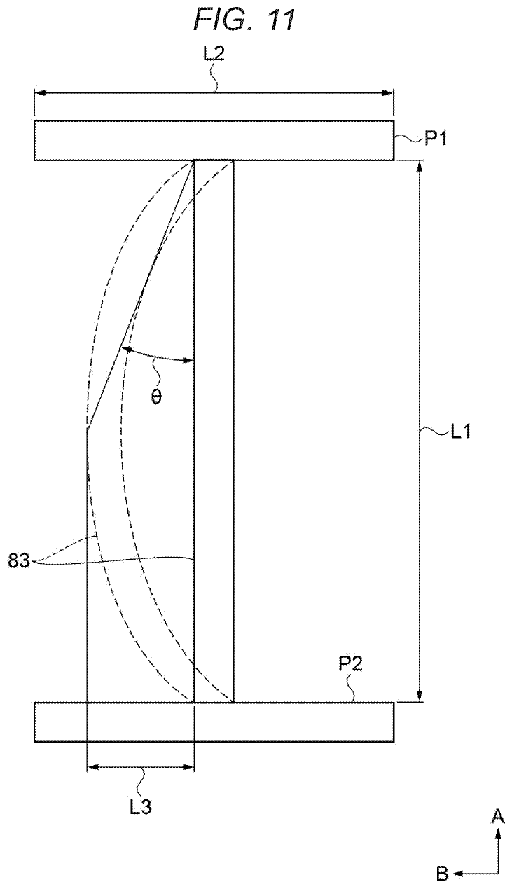

The flexure of the round cable 83 will now be described. As illustrated in FIG. 11, it is assumed that a part of the round cable 83 is held at an interval of a distance L1 by fixtures P1 and P2. In FIG. 11, the flexing round cable 83 is indicated by a broken line. The width of each of the fixtures P1 and P2 is a width L2.

It is assumed that the round cable 83 flexes such that the center between the fixture P1 and the fixture P2 protrudes in the +B direction by a distance L3 from the original position indicated by a solid line, and the angle formed by the center and the fixing position by the fixture P1 is defined as an angle θ. At this time, since the round cable 83 can move in the range of the width L2 at the positions of the fixture P1 and the fixture P2, an equation L3=(L1×tanθ+L2)/2 holds for the maximum value of the distance L3 of protrusion.

That is, the distance L3 increases as the distance L1 increases. Specifically, for example, when the distance L1 is 90 mm, the width L2 is 11 mm, and the angle θ is 30 degrees, the distance L3 is 31 mm. That is, it is estimated that the round cable 83 flexes and protrudes by a maximum of 31 mm with respect to the center between the fixture P1 and the fixture P2. When the round cable 83 is disposed in the vicinity of the cover part 2a, in a configuration in which the guide part 100 is not provided, the flexing round cable 83 is more likely to be sandwiched or come into contact with the insertion part 201 when attaching the cover part 2a.

However, when the guide part 100 is used, the distance L1 can be reduced. For example, when the distance L1 is reduced to 35 mm by the guide part 100, the distance L3 is 15.6 mm from the above equation. Even when a certain member is present in the direction in which the round cable 83 flexes and protrudes, it is sufficient that there is a clearance of about 16 mm with respect to the center between the fixture P1 and the fixture P2. The guide part 100 also has a function of suppressing the protrusion of the round cable 83 due to the flexure thereof.

The guide part 100 is configured to guide the cable 80 and suppress the flexure of the cable 80. The guide part 100 also has a function of flexing and releasing an external force even when the guide part 100 itself comes into contact with the cover part 2a or the like. The case where the guide part 100 and the cover part 2a come into contact with each other will be described later.

A case where the insertion part 201 comes into contact with the cover part 2a when the cover part 2a is attached to the frame 40 will now be described. As illustrated in FIG. 12, when the insertion part 201 comes into contact with the cover part 2a in the process of attaching the cover part 2a, it is preferable that the insertion part 201 comes into contact with the first surface 103a of the holding part 103 and does not come into contact with the second surface 103b of the holding part 103.

According to this configuration, when the cover part 2a is attached to the frame 40, the insertion part 201 is brought close to the first surface 103a of the guide part 100 until the insertion part 201 comes into contact with the first surface 103a, and therefore space efficiency is improved. Also, since the insertion part 201 is brought into contact with the first surface 103a, the guide part 100 flexes and escapes due to the flexibility thereof, and therefore the guide part 100 is prevented from being sandwiched between the insertion part 201 and the frame 40. Moreover, when an irregular attachment is performed, since the insertion part 201 comes into contact with the second surface 103b, the attachment of the cover part 2a is inhibited due to the rigidity of the guide part 100 having a rectangular shape when viewed from above. Therefore, the operator can easily notice that the attachment method is wrong.

The contact of the first surface 103a with the insertion part 201, and the non-contact of the second surface 103b with the insertion part 201 can be adjusted by the arrangement of the insertion part 201 and the dimension thereof along the Y axis, the arrangement of the guide part 100, the dimension of the first surface 103a along the Y axis, the dimension of the second surface 103b along the X axis, and the like.

When the contact between the insertion part 201 and the holding part 103 is slight in the process of attaching the cover part 2a, the contact of the insertion part 201 with the second surface 103b may be allowed. That is, when the contact is slight, the holding part 103 only flexes and the external force does not spread to the cable 80, or the insertion part 201 escapes and moves away after temporarily coming into contact with the holding part 103.

Although not illustrated, it is preferable that the distance between the distal end 103e of the holding part 103 and the rib 203 of the cover part 2a is shorter than the distance between the distal end 103e of the holding part 103 and the insertion part 201. Thus, the rib 203 can be brought closer to the guide part 100.

According to this configuration, the position where the distal end 103e engages with the opening 101c in the protection part 101 is closer to the rib 203 than the insertion part 201. Meanwhile, since the rib 203 is closer to the guide part 100, there is a high risk that the rib 203 may come into contact with the guide part 100 when the cover part 2a is attached. However, according to the above configuration, when the rib 203 comes into contact with the guide part 100, the rib 203 comes into contact with the distal end side of the holding part 103. Therefore, when the rib 203 comes into contact with the holding part 103 at the time of attaching the cover part 2a to the frame 40, the external force acting on the holding part 103 from the rib 203 acts to strengthen the engagement between the holding part 103 and the protection part 101. Therefore, even when the rib 203 comes into contact with the holding part 103, the function of the guide part 100 can be maintained.

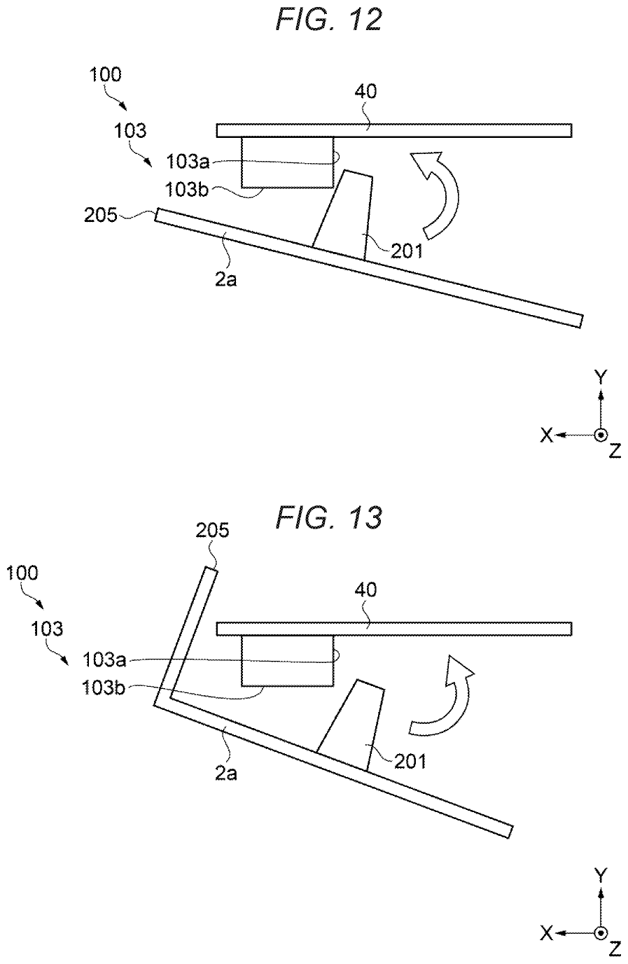

Also, as illustrated in FIG. 13, even when the position of the end part 205 of the cover part 2a serving as the rotation center is changed at the time of attaching the cover part 2a to the frame 40, the contact of the first surface 103a with the insertion part 201 and the non-contact of the second surface 103b with the insertion part 201 can be adjusted.

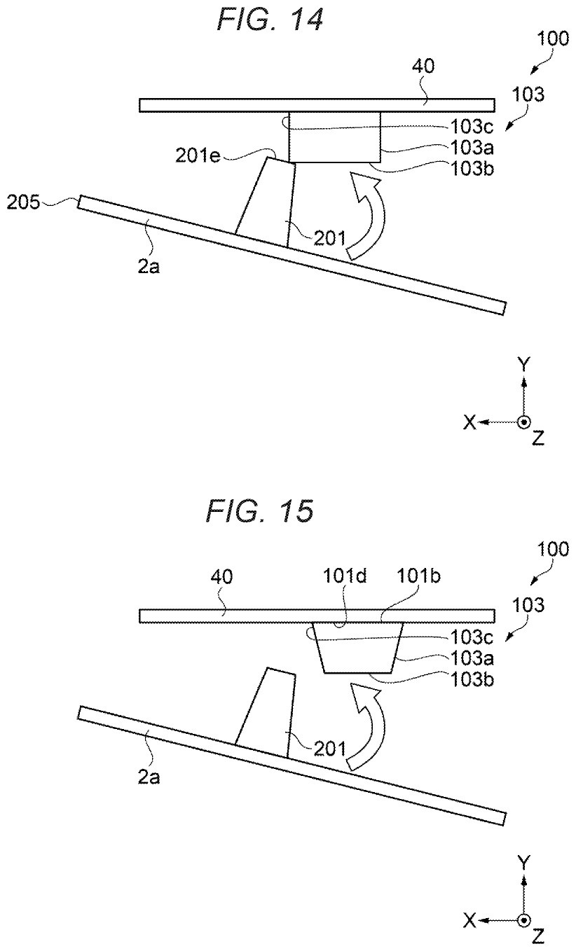

As illustrated in FIG. 14, in a direction along the X axis, the insertion part 201 is located in the +X direction with respect to the guide part 100, and when the cover part 2a is attached to the frame 40, the protruding end 201e may come into contact with the second surface 103b of the holding part 103.

In the above case, the shape formed by the holding part 103 and the second part 101b of the protection part 101 may be a trapezoidal shape when viewed from above, as shown in FIG. 15. Specifically, the guide part 100 surrounds the cable 80 in a quadrangular shape when viewed from above, and has a first surface 103a, a second surface 103b, a surface 103c, and a third surface 101d. The third surface 101d is a surface facing the −Y direction of the second part 101b in the protection part 101. The second surface 103b is a surface bent from the first surface 103a, and the third surface 101d faces the back surface of the second surface 103b.

In the state where the cover part 2a is attached to the frame 40, the surface 103c faces the insertion part 201, the second surface 103b faces the cover part 2a, and the third surface 101d faces the frame 40. When applied to the configuration shown in FIG. 12, in the state where the cover part 2a is attached to the frame 40, the first surface 103a faces the insertion part 201, the second surface 103b faces the cover part 2a, and the third surface 101d faces the frame 40. The area of the second surface 103b is smaller than the area of the third surface 101d.

That is, when viewed from above, the trapezoid formed by the first surface 103a, the second surface 103b, the surface 103c, and the third surface 101d has a shape that becomes smaller as it goes toward the −Y direction. Since the second surface 103b is smaller than the third surface 101d, the insertion part 201 is less likely to come into contact with the second surface 103b when the cover part 2a is attached to the frame 40. Therefore, the guide part 100 can be prevented from being sandwiched between the insertion part 201 and the frame 40.

The shape formed by the first surface 103a, the second surface 103b, the surface 103c, and the third surface 101d when viewed from above is not limited to a trapezoid, and may be any shape that becomes smaller as it goes toward the −Y direction. Specifically, a polygon, a semicircle, or the like may be employed.

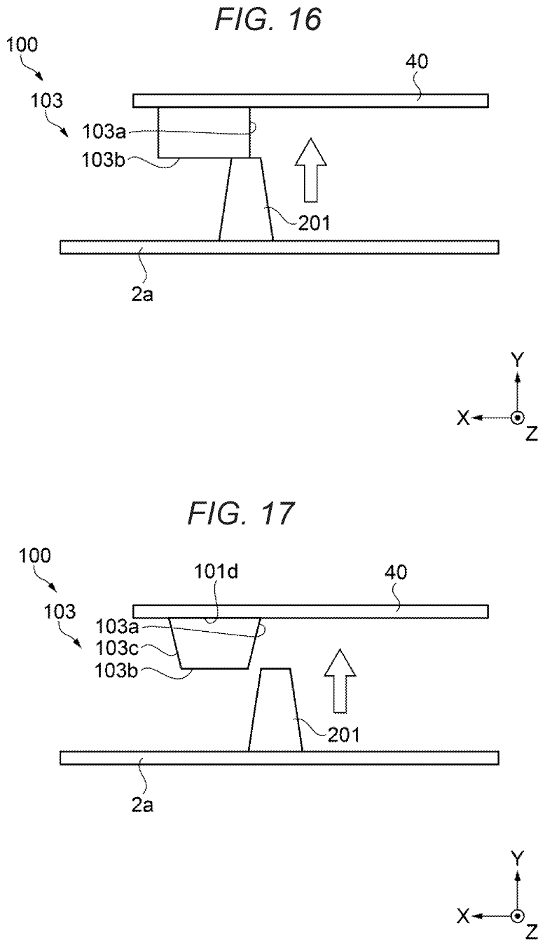

Also, in a configuration in which the holding part 103 and the insertion part 201 are disposed adjacent to each other and the cover part 2a is attached by being pushed in the +Y direction without being rotated, the insertion part 201 and the second surface 103b of the holding part 103 may come into contact with each other, as illustrated in FIG. 16.

In the above case, as illustrated in FIG. 17, the first surface 103a, the second surface 103b, the surface 103c, and the third surface 101d may form a trapezoidal shape when viewed from above, as in the configuration shown in FIG. 15. According to this configuration, since the guide part 100 has a shape that escapes from the insertion part 201 pushed in the +Y direction, these parts can avoid contact with each other or may come into contact only slightly.

The present embodiment can achieve the following effects.

The cable 80 can be protected by the guide part 100. Specifically, the guide part 100 is disposed between the welding area 44 and the cable 80. Even when an edge or a build-up of the frame 40 is present in the welding area 44, damage to the cable 80 due to sliding contact between the edge or the build-up and the cable 80 is suppressed. Also, since the guide part 100 is flexible, even when an external force acts thereon, the guide part 100 can flex and deflect the external force. Therefore, the external force can be prevented from spreading to the cable 80. Thus, the electronic device 5 and the printer 1 in which the cable 80 accommodated therein is protected can be provided.

A wiring clamp or the like need not be installed for the arrangement of the cable 80. A general clamp or the like may require processing such as opening a hole at an attachment position, and therefore it is difficult to attach a general clamp or the like to the welding area 44. However, the guide part 100 is a flexible member and therefore is easily provided even in the welding area 44. The guide part 100 can be easily attached to the frame 40 with a simple configuration. Also, since the cable 80 overlaps the welding area 44, the cable 80 can be easily routed as compared with a configuration in which the cable 80 is disposed to avoid the welding area 44. Therefore, the electronic device 5 and the printer 1 can be easily miniaturized.

What is claimed is:

1. An electronic device comprising:
a frame;
a cable disposed along the frame; and
a guide part attached to the frame and configured to guide the cable, wherein
the frame is formed by welding a first metal plate and a second metal plate in a welding area,
the cable overlaps the welding area, and
the guide part includes a flexible part interposed between the welding area and the cable.

2. The electronic device according to claim 1, wherein
the guide part includes
a protection part interposed between the welding area and the cable, and
a holding part extending from the protection part and surrounding the cable, and
a distal end of the holding part is fixed to the protection part.

3. The electronic device according to claim 2, wherein
the first metal plate extends in a first direction,
the second metal plate extends in a second direction intersecting the first direction,
the cable is disposed along the first metal plate and the second metal plate, and
the protection part includes
a first part extending in the first direction and interposed between the first metal plate and the cable, and
a second part extending in the second direction and interposed between the second metal plate and the cable.

4. The electronic device according to claim 1, wherein
the cable includes a flexible flat cable.

5. The electronic device according to claim 1, wherein
the cable includes a flexible flat cable and a round cable, and
the flexible flat cable and the round cable are arranged in this order from a side closer to the frame.

6. The electronic device according to claim 1, further comprising:
a cover part attached to the frame and covering the cable and the guide part.

7. The electronic device according to claim 6, wherein
the cover part includes an insertion part through which a fastener fastened to the frame is inserted, and
the insertion part and the guide part overlap each other when viewed in a direction along the frame.

8. The electronic device according to claim 7, wherein
the guide part surrounds the cable in a rectangular shape and has a first surface,
the first surface faces the insertion part in a state where the cover part is attached to the frame, and
the insertion part does not come into contact with the first surface in a process of attaching the cover part.

9. The electronic device according to claim 7, wherein
the guide part surrounds the cable in a rectangular shape and has a first surface and a second surface bent from the first surface,
the first surface faces the insertion part and the second surface faces the cover part in a state where the cover part is attached to the frame, and
the insertion part comes into contact with the first surface and does not come into contact with the second surface in a process of attaching the cover part.

10. The electronic device according to claim 7, wherein
the guide part surrounds the cable in a quadrangular shape and has a first surface, a second surface bent from the first surface, and a third surface facing the second surface,
the first surface faces the insertion part, the second surface faces the cover part, the third surface faces the frame, in a state where the cover part is attached to the frame, and
an area of the second surface is smaller than an area of the third surface.

11. The electronic device according to claim 7, wherein
the cover part is attached to the frame while rotating, and
in a state where the cover part is attached to the frame, the guide part is located between a rotation center of the cover part with respect to the frame and the insertion part.

12. The electronic device according to claim 7, wherein
the cover part includes a rib protruding toward the frame, and
the guide part is located between the rib and the insertion part in a state where the cover part is attached to the frame.

13. The electronic device according to claim 12, wherein
the guide part includes
a protection part interposed between the welding area and the cable, and
a holding part extending from the protection part and surrounding the cable,
a distal end of the holding part is inserted in and engaged with the protection part, and
a distance between the distal end of the holding part and the rib is shorter than a distance between the distal end of the holding part and the insertion part.

14. A recording device comprising:
the electronic device according to claim 1; and
a recording unit that performs recording on a medium.

15. The recording device according to claim 14, further comprising:
a control unit provided to a rear of a device main body; and
an operation unit provided to a front of the device main body, wherein
the cable is a signal line coupling the operation unit and the control unit.
